(19) United States
(12) Patent Application Publication
(10) Pub. No.: US 2021/0348634 A1
(43) Pub. Date: Nov. 11, 2021

(54) Method for Connecting a First Component to a Second Component

(71) Applicant: Bayerische Motoren Werke Aktiengesellschaft, Muenchen (DE)

(72) Inventor: Ulrich OHNEMUS, Hattenhofen (DE)

(21) Appl. No.: 17/283,616

(22) PCT Filed: Sep. 25, 2019
(86) PCT No.: PCT/EP2019/075789

§ 371 Date: Apr. 8, 2021

(30) Foreign Application Priority Data
Oct. 10, 2018 (DE) 10 2018 124 966.7

(51) Int. Cl. F16B 13/12; F16B 5/02

(52) U.S. Cl. CPC F16B 13/124; B60K 17/00; F16B 5/0283; F16B 5/0233

(57) ABSTRACT

A method connects a first component to a second component. The first component is located at a distance to the second component. The method includes: providing a spacer element which has a sleeve-shaped section with a through-opening and an outer thread; screwing the spacer element with the outer thread into a threaded bore which is provided in the second component; screwing the spacer element into a screwed position in which the spacer element protrudes out of the threaded bore such that the spacer element bridges the distance between the first and the second component, wherein the end face of the spacer element rests against the first component side facing the second component; and clamping together the two components and the spacer element by way of a screw which is screwed into the sleeve-shaped section of the spacer element or which passes through the sleeve-shaped section of the spacer element.

### BACKGROUND AND SUMMARY OF THE INVENTION

The present invention relates to a method for connecting a first component to a second component, wherein the first component is at a distance from the second component.

The object of the invention is to define a method for connecting two components, with which two components which are spaced apart at the connecting point can be fixedly connected to one another in a simple and assembly-friendly manner.

This object is achieved by the features of the independent claim. Advantageous embodiments and refinements of the invention can be gleaned from the subclaims.

The basis of the invention is a method for connecting a first component to a second component, wherein the first component is located at a distance from the second component.

For the “bridging” of the tolerance-sensitive spacing between the two components, a spacer element is provided. The spacer element has a sleeve-shaped portion having a through opening and an external thread. The spacer element is screwed with its external thread into a threaded bore which is provided in the second component.

After this, the spacer element is screwed or rotated into a screwing position in which it juts out of the threaded bore in such a way that it bridges the spacing which exists between the first and the second component in the region of the “connecting point” such that an end face of the spacer element bears against a side of the first component that is facing toward the second component, in order to ensure the axial interference fit between the first and the second component in spite of mutually spaced positioning in the axial direction. After this, the two components and the spacer element are clamped together by means of a screw which is screwed into the sleeve-shaped portion of the spacer element or passes through the sleeve-shaped portion.

The invention is suitable for a large number of applications. One conceivable application is the arrangement of a transmission casing on an engine casing, for example on a casing of an internal combustion engine. At a first “attachment point”, two machined surfaces of the engine casing and of the transmission casing can be screwed directly to one another. In order to connect the transmission casing reliably and with high strength to the engine casing, at least a second connecting point should be provided. Due to the positional tolerances, it is of advantage, in particular in respect of cast casings, if at the second connecting point a certain spacing or a certain play can exist prior to assembly. The invention can be used to bridge this spacing or play. The clearance (i.e. the clear spacing plus axial tolerances) of the second attachment point is aligned to the first attachment point. The first attachment point thus constitutes the primary aligning and determinant “screwing situation”.

According to one refinement of the invention, a spacer element which, at its end facing toward the first component, has a shoulder which overhangs the threaded bore provided in the second component is used as the spacer element. The shoulder can be configured, for example, as an annular shoulder, the end face of which forms the abovementioned end face which then bears against the first component.

Furthermore, it can be provided that the through opening provided in the spacer element has a larger diameter than a threaded portion of the screw with which the two components are clamped together. As a result, radial tolerance positions between the first and the second component can be compensated, i.e. they have no influence on the clamping situation.

In this case, the screw can easily extend through the sleeve-shaped portion of the spacer element without being screwed thereto.

Alternatively thereto, the through opening provided in the spacer element can also be provided with an internal thread into which the screw is screwed.

According to one refinement of the invention, it is provided that the sleeve-shaped portion of the spacer element has a polygonal socket, for example a hexagon socket, or a different internal geometry by way of which, with a tool, a form closure can be established in the rotational direction and thus the axial position of the spacer element adjusted. This has the advantage that the spacer element can be rotated or screwed, by means of a tool cooperating with the polygonal socket (for example by means of a so-called “Allen key”), into the screwing position in which the end face of the spacer element comes to bear against the first component.

According to one refinement of the invention, it is provided that the screw is positioned such that a head of the screw bears against the second component from a side of the second component that is facing away from the first component.

It can further be provided that the threaded portion of the screw is screwed directly into the first component.

Alternatively thereto, it can be provided that the threaded portion of the screw passes through a through bore provided in the first component, and that a nut is screwed onto the free end of the threaded portion of the screw from a side of the first component that is facing away from the second component, and the two components are thus clamped together by tightening of the nut. In this case, it can further be provided that the through bore provided in the first component has a sufficiently larger diameter than the external diameter of the threaded portion of the screw. In this way, any positional tolerances of the first component can then also be compensated in relation to the second component in directions perpendicular to the longitudinal direction of the screw that clamps together the two components.

If a nut is employed, there is the possibility of compensating the positional tolerances between the first and the second component still better. The accessibility of the nut, the counterbalancing of the tightening torque, is revealed by a solution comprising a holding plate or a holding cage for the nut. The holding cage constitutes a means of protection against loss and twisting. The nut can however assume its position radially freely within certain limits within this means of protection.

The nut is positioned on the first component, after which the holding cage is slipped over and connected in a non-detachable manner to the first component, for example by welding. The screw with the thread-on tip reaches into the threaded bore of the nut. The screw can be introduced and tightened from the right without the nut having to be held in place with a tool.

The invention is explained in greater detail below in association with the drawings.

### BRIEF DESCRIPTION OF THE DRAWINGS

FIG. 1 illustrates a practical application example of the invention in association with an engine/transmission arrangement.

FIGS. 2 to 4 show the steps according to the invention for clamping together the two components.

FIG. 5 is a perspective representation of a spacer element according to an embodiment of the invention.

### DETAILED DESCRIPTION OF THE DRAWINGS

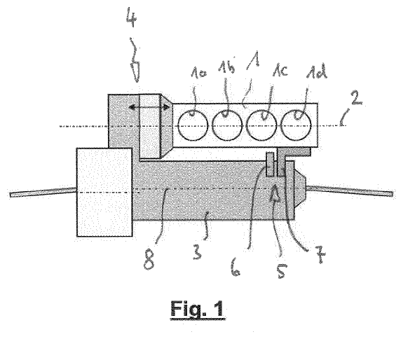

FIG. 1 shows an internal combustion engine casing 1 comprising four cylinders 1a-1d arranged side-by-side in line. The longitudinal direction of the internal combustion engine 1 is indicated by a center line 2.

Alongside the internal combustion engine casing 1 is arranged a transmission, which has a transmission casing 3.

In a first supporting region 4, the internal combustion engine casing 1 and the transmission casing 3 are screwed directly to one another. The first supporting region is the primary, determinant connecting region between the internal combustion engine casing 1 and the transmission casing 3. To this connecting region are aligned the further tolerance actual positions for a second “attachment point” (supporting region 5).

In addition to this first attachment region 4, the internal combustion engine casing 1 and the transmission casing 3 are connected to one another in the second supporting region 5. In the second supporting region 5 is provided a first flange element, which is referred to below as the “first component 6”

The first flange element or the first component 6 can be, for example, a “cast ear”, which protrudes on the outside from the transmission casing 3.

A second flange element, which is referred to below as the second component 7, protrudes from the outside from the internal combustion engine casing. The second component 7 can be constituted, for instance, by an angle bracket, which is screwed from the outside to the internal combustion engine casing 1. Alternatively thereto, the second component 7 can also be constituted by a “cast ear”, which protrudes from the outside from the internal combustion engine casing 1.

As can already be seen from FIG. 1, the first component 1 and the second component 2 have in the longitudinal direction 2 of the internal combustion engine casing 1, or in the longitudinal direction 8 of the transmission casing 3, a certain spacing or a certain play. This spacing or play is necessary if a problem-free assembly or screwing together of the internal combustion engine casing and transmission casing 3 in the region of the second supporting region 5 in the longitudinal direction 2 of the internal combustion engine casing 1, or in the longitudinal direction 8 of the transmission casing 3, is to be possible.

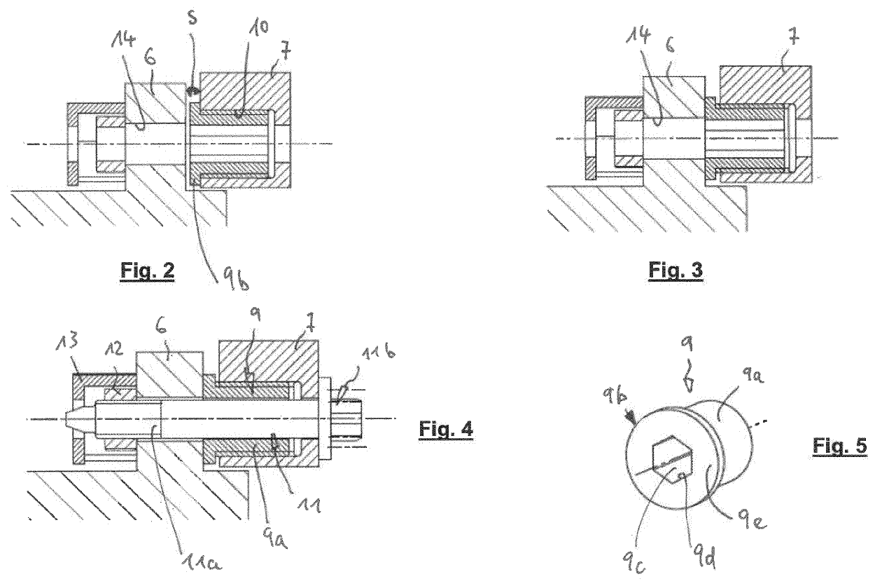

In FIGS. 2-4, it is now explained in greater detail how the two components, namely the first component 6 and the second component 7, between which there is a gap s, are screwed together.

For the screwing together of the two components 6, 7, a spacer element 9 (cf. FIG. 5) is used. The spacer element 9 has a sleeve-shaped portion 9a, which is provided with an external thread. Adjoining the sleeve-shaped portions 9a is a shoulder 9b. The spacer element 9 further has a through opening 9c, which is here configured as a hexagon socket 9d.

In the second component 7 is provided a threaded bore 10, into which the sleeve-shaped portion 9a of the spacer element 9 is screwed, to be precise such that the shoulder 9b overhangs the threaded bore 10 provided in the second component 7.

As represented in FIGS. 2 and 3, in order to bridge the spacing between the two components 6, 7, which spacing is denoted in the figure with the reference symbol s, the spacer element 9 is rotated or screwed into a position in which an end face 9e (cf. FIG. 5) of the spacer element 9 bears against a side of the first component 6 that is facing toward the second component 7.

After this, the two components 6, 7 and the spacer element 9 are clamped together by means of a screw 11. The screw 11 has a shaft portion or threaded portion 11a, which passes through the sleeve-shaped portion 9a of the spacer element 9. As can be seen from FIG. 4, the shaft portion or threaded portion 11a also extends through a through opening 14 provided in the first component 6.

A head 11b of the screw 11 bears against that side of the second component 7 that is facing away from the first component 6. The actual clamping together of the two components 6, 7 and of the spacer element 9 is realized by means of a nut 12, which, from the free end of the screw 11, is screwed onto the threaded or shaft portion 11a of the screw 11.

As can be seen from FIGS. 2-4, there is additionally provided a screw locking plate or screw locking element 13 which prevents the nut 12 from spontaneously or inadvertently coming loose. The screw locking element 13 is a type of holding cage and twist protection mechanism. For locking purposes, the screw can possess a microencapsulation with an adhesive, or the nut can have an appropriate ribbing in the contact surface to the component 1, or there is another type of locking mechanism.

As already explained above, with the connection represented in FIGS. 2-4, two cast casings or cast elements, or therewith connected connecting elements, can be easily screwed together, to be precise even when, for reasons of ease of assembly, a certain play or a certain spacing is or must be present at screwing points in the direction of screwing. The ease of assembly, axial accessibility and handling just from one side (in the figures from outside right) are fundamental advantages of the invention.

1-8. (canceled)

9. A method for connecting a first component to a second component, wherein the first component is at a distance from the second component, comprising:
providing a spacer element, which has a sleeve-shaped portion having a through opening and an external thread;
screwing the spacer element having the external thread into a threaded bore which is provided in the second component;
screwing the spacer element into a screwing position in which the spacer element protrudes out of the threaded bore so as to bridge the spacing between the first and the second component, wherein an end face of the spacer element butts against a side of the first component that is facing toward the second component;
clamping together the first and second components and the spacer element by way of a screw, which screw is screwed into the sleeve-shaped portion of the spacer element or passes through the sleeve-shaped portion of the spacer element.

10. The method according to claim 9, wherein
the spacer element which, at an end facing toward the first component, has a shoulder which overhangs the threaded bore provided in the second component.

11. The method according to claim 9, wherein
the through opening of the spacer element has a larger diameter than a threaded or shaft portion of the screw, and
the threaded or shaft portion passes through the spacer element.

12. The method according to claim 9, wherein
the sleeve-shaped portion of the spacer element has a polygonal socket, and
the spacer element is screwed into the screwing position by use of a tool which cooperates with the polygonal socket.

13. The method according to claim 9, wherein
the screw is positioned such that a head of the screw bears against the second component from a side of the second component that is facing away from the first component.

14. The method according to claim 11, wherein
the threaded or shaft portion of the screw is screwed into the first component.

15. The method according to claim 11, wherein
the threaded or shaft portion of the screw passes through a through bore provided in the first component, wherein a nut is screwed onto the threaded or shaft portion from a side of the first component that is facing away from the second component.

16. The method according to claim 15, wherein
the through bore provided in the first component has a larger diameter than the threaded or shaft portion of the screw.
